(19) United States
(12) Patent Application Publication
(10) Pub. No.: US 2025/0067897 A1
(43) Pub. Date: Feb. 27, 2025

(54) METHOD AND SYSTEM FOR TUNNEL ELECTROMAGNETIC JOINT SCANNING

(71) Applicant: Yangtze Delta Region Institute (Huzhou), University of Electronic Science and Technology of China, Huzhou City (CN)

(72) Inventors: Lu GAN, Huzhou City (CN); Rongjiang TANG, Huzhou City (CN)

(73) Assignee: Yangtze Delta Region Institute (Huzhou), University of Electronic Science and Technology of China, Huzhou City (CN)

(21) Appl. No.: 18/479,790

(22) Filed: Oct. 2, 2023

(30) Foreign Application Priority Data
Aug. 25, 2023 (CN) 2023110846896

(51) Int. Cl. G01V 3/38; G01V 3/12

(52) U.S. Cl. CPC G01V 3/38; G01V 3/12

(57) ABSTRACT

Provided herein is a tunnel electromagnetic joint scanning detection method and a system thereof. It introduces a new tunnel electromagnetic detection system called TEJS, realizes three-dimensional joint inversion of multi-component, time domain and frequency domain signals, and forms tunnel joint scanning imaging. This method adopts the mode of surface transmission, underground reception, multi-source transmission and multi-component reception. Based on an observation system, a large number of stochastic models are constructed and numerically simulated, and a large number of training data sets are constructed by using the simulated data to complete the training of UNet model. This model can realize real-time and fast imaging of the position of the low-resistance anomalous body in three-dimensional space. An algorithm forms a dual checking mechanism through surface imaging and underground imaging, which constrains the three-dimensional spatial position of anomalous body together to prevent misjudgment.

### RELATED APPLICATIONS

This application claims priority under 35 U.S.C. § 119(a) to Chinese Patent Application No. 2023110846896, filed on Aug. 25, 2023, which is hereby incorporated by reference herein in its entirety.

### FIELD OF THE INVENTION

The present disclosure belongs to the technical field of tunnel advanced prediction, in particular to a method, a system, a device and a medium for tunnel electromagnetic joint scanning detection.

### BACKGROUND OF THE INVENTION

Transient electromagnetic (TEM) method is widely used to identify low resistivity areas before tunnel construction to predict serious geological disasters such as water inrush, mud inrush and collapse. Based on the obvious conductivity difference between the underground detection target body and the surrounding rock, the method realizes the detection of underground strata, goaf and karst distribution by studying the variation law of transient field with time.

At present, transient electromagnetic advanced prediction mainly adopts a central loop apparatus to observe on the tunnel face and transmit and observe signals inside the tunnel. Usually, the transportation cost of high-power generators is high, and there is deflagration risk when applied in areas such as coal mines. Therefore, combined batteries are usually used to supply power to the transmission source in these areas, which leads to a low signal-to-noise ratio due to limited transmit power. Moreover, due to the narrow space in the tunnel and the limited coverage of observation points, less effective information is obtained, which will inevitably lead to the non-uniqueness of inversion being stronger than that of ground transient electromagnetic. Secondly, under the existing working mode, the current tunnel transient electromagnetic technology usually collects the magnetic field component or induced electromotive force perpendicular to the coil plane, while ignoring the electromagnetic field data in other directions. However, the spatial distribution of electromagnetic field caused by anomalies is three-dimensional, depending on different receiving and transmitting positions and underground resistivity structure, the sensitivity of electromagnetic field signals in different directions to anomalies varies greatly. Therefore, if only vertical components are used to detect underground anomalies, important effective information will be lost. In addition, the current TEM tunnel detection is mainly one-dimensional, because the one-dimensional inversion is based on layered media, the inversion results are not enough to describe the three-dimensional uneven underground space, so the inversion results are prone to false anomalies, and the inversion is unstable and the lateral continuity is poor.

Through the above analysis, the problems and defects existing in the prior art are as follows: (1) the existing tunnel advanced prediction electromagnetic observation system has low construction efficiency, small observation data coverage area, low signal-to-noise ratio, etc.; and (2) because the tunnel space is limited, the constraint of observation data on the inversion model is weak, and the inversion is mainly one-dimensional layered model, which is not enough to describe the three-dimensional uneven underground space, and is prone to false anomalies, and the inversion is unstable and the lateral continuity is poor, so the tunnel TEM advanced prediction has great uncertainty and non-uniqueness.

### SUMMARY OF THE INVENTION

Aiming at the problems existing in the prior art, the present disclosure provides a method, a system, a device and a medium for tunnel electromagnetic joint scanning detection. The present disclosure aims to introduce a new tunnel electromagnetic detection system, called (Tunnel Electromagnetic Joint Scanning) TEJS, to realize three-dimensional joint inversion of multi-component, time domain and frequency domain signals, and form a tunnel joint scanning imaging mode to be used for predicting a low resistance body in front of a tunnel.

The present disclosure is realized as follows: a method for tunnel electromagnetic joint scanning detection, comprising:
step 1, using a new tunnel electromagnetic detection system to form a tunnel joint scanning imaging mode, adopting the modes of surface transmission, underground reception, multi-source transmission and multi-component reception, during a detection process, parallel transmission source moves along the x-axis, scans underground media, and carries out surface and underground imaging until the whole target area is covered;
step 2, establishing a large number of tunnel resistivity stochastic models based on an observation system, simulating electromagnetic field data in time domain and frequency domain based on a finite volume method, using the simulated data as the input for a neural network, and using the spatial positions of low-resistance anomalies in the resistivity model as the output, establishing a training set and a test set;
step 3, constructing a UNet, establishing a loss function, preprocessing training data, and then training network, adjusting parameters based on prediction accuracy, and obtaining an optimal prediction model;
step 4, importing the measured data into UNet to rapidly predict the spatial position of low resistance water body near the tunnel.

Further, the method for tunnel electromagnetic joint scanning detection uses three parallel surface transmission sources to transmit electromagnetic field signals in turn, a receiving coil works near the excavation surface; and a transmitting coil alternately transmits two types of signals.

The first type is a step current signal, which is used to generate pulsed electromagnetic field for TEM detection;

The second type is a harmonic signal, and the received signal is converted into frequency magnetic field signal through fast Fourier transform; the observation mode of three components (x, y, z) is adopted.

Further, in each scanning step in the step 1, three transmission sources are randomly arranged in separate sections (y∈[−30, −10], [−10, 10], [10, 30]) along the parallel direction of the x-axis, or one transmission source can be used to scan the three separate sections in sequence; and the tunnel electromagnetic joint scanning detection method takes the simulated observation data corresponding to the three transmission sources as a training sample.

Further, the underground low-resistivity water body imaging in the step 1 is completed based on a deep learning algorithm, wherein the surface imaging refers to the projection of the low-resistivity anomalous body in a rectangular area composed of three parallel surface transmission sources, and the underground imaging is to project the anomalous body onto a two-dimensional coordinate system composed of azimuth angle and polar angle, and the three-dimensional spatial position of the anomalous body is finally determined by integrating the results of the surface imaging and the underground imaging.

Further, the method for tunnel electromagnetic joint scanning detection establishes a deep learning model, and firstly establishes a three-dimensional resistivity model training set, wherein the resistivity changes linearly from shallow layer to deep layer, the tunnel is filled with air, and the above ground is also air; the anomalous body with low resistivity is randomly introduced around the tunnel, and the distance from the excavation face of the tunnel varies from 10 meters to 35 meters, the resistivity value of the anomalous body follows the logarithmic uniform distribution log 10(ρ)∈[−1, 1] Ω·m; the finite volume method is used to calculate forward in time domain and frequency domain, and the training data set is constructed; the UNet model is constructed and trained by using the simulated data sets, and the model is optimized by iterative adjustment of model parameters.

Further, the input of the neural network of the method for tunnel electromagnetic joint scanning detection in the step 2 comprises three-component time-domain induced electromotive force data and three-component frequency-domain magnetic field data, as well as frequency, turn-off time and spatial information channels, wherein the spatial information channels are vector information from the measuring point to the transmission source, represented by azimuth angle and polar angle, and represented by distance in spherical coordinates, and represented as three one-dimensional vectors; two processing methods are applied to time domain and frequency domain data, and the processed data are used as two separate channels: (1) normalization and (2) taking absolute value and then taking logarithm; and when each transmission source transmits a signal, two channels of data are collected to increase the proportion of effective information, so each sample comprises a total of six channels of input data.

Further, the output of the neural network of the method for tunnel electromagnetic joint scanning detection in the step 2 comprises two channels, and the output is the inversion result, including:
(1) underground imaging: a spherical coordinate system is established, the center of the anomalous body is taken as the target point, and the position of the receiving coil is taken as the origin; then, θ is used as horizontal coordinate and q is used as vertical coordinate to represent the spatial position information of the model, and two-dimensional Gaussian distribution is applied around the generated model position, and the highest point represents the position of the anomalous body; in the prediction stage, the precise position of anomalous body is determined by identifying the peak value of prediction probability distribution; and
(2) surface imaging: Gaussian distribution of the projection of low resistivity anomalies on the surface, and the projection area is a rectangular surface area composed of three transmission sources.

Further, in the construction and training of the neural network of the method for tunnel electromagnetic joint scanning detection in the step 3, the UNet network is used to predict the nonlinear mapping between the electromagnetic signal and the spatial distribution of the low resistance anomalous body, the model adopts the ReLU activation function and applies it to the output of the convolution layer, after the convolution operation, the batch normalization is applied to standardize the data, and the Sigmoid function is applied to the last layer to limit the output result to [0, 1]; the optimal hyperparameters of step size and filter kernel size will be determined through multiple tests to find the most suitable values, and the cross entropy function is adopted to measure the proximity between the prediction variable q_i(x) and the corresponding label p_i(x), where:

$$H ( p , q ) = {H}_{1} ( p , q ) + {H}_{2} ( p , q )$$

$${H}_{1} ( p , q ) = - {\sum }_{i = 1}^{2} {\sum }_{x}^{} {p}_{i} ( x ) log {q}_{i} ( x )$$

$${H}_{2} ( p , q ) = - {\sum }_{i = 1}^{2} {\sum }_{x}^{} {p}_{i} ( x ) log {q}_{i} ( x )$$

i=1 and i=2 denote the presence or absence of low resistivity anomalies respectively, x denotes the spatial location of the output neurons, and H1 and H2 correspond to the output channels of surface imaging and underground imaging respectively.

Another object of the present disclosure is to provide a system for electromagnetic joint scanning detection, the system for tunnel electromagnetic joint scanning detection comprises:
a tunnel electromagnetic observation module, which is used to collect effective electromagnetic field information;
a training set and test set module, which is used to train and test tunnel resistivity stochastic model;
a prediction model optimization module, which is used to optimize the model to obtain an optimal prediction model; and
a rapid prediction module, which is used to rapidly predict the spatial position of low resistance water body near the tunnel.

Another object of the present disclosure is to provide a computer device including a memory and a processor, the memory storing a computer program that, when executed by the processor, causes the processor to perform the method for tunnel electromagnetic joint scanning detection.

Another object of the present disclosure is to provide a computer-readable storage medium storing a computer program that, when executed by a processor, causes the processor to perform the method for tunnel electromagnetic joint scanning detection.

Combined with the technical scheme and the technical problem solved, the technical scheme claimed by the present disclosure has the advantages and positive effects as follows:

Firstly, the parameter inversion method based on deep learning of the present disclosure improves the traditional tunnel electromagnetic imaging method. The method relates to an observation system for tunnel electromagnetic joint scan (TEJS), which utilizes surface transmission and underground reception, as well as multi-source transmission and multi-component reception modes. This configuration can conveniently utilize high-power transmission, thereby improving the coverage and signal-to-noise ratio of observation data. Based on the system, the present disclosure provides a parameter inversion method based on deep learning, which is used for predicting the water-bearing structure in front of the tunnel. The trained neural network can quickly and accurately predict the three-dimensional position of low resistance anomalous body. In addition, the deep learning model provides anomalous imaging from two different perspectives, forming a self-checking mechanism for prediction, which is particularly important for evaluating inversion results.

Secondly, the dual imaging mechanism of the present disclosure can check the reliability of inversion, and can identify false anomalies caused by inversion non-uniqueness. The present disclosure introduces a new tunnel electromagnetic detection system called TEJS, and based on this, proposes a parametric inversion algorithm based on deep learning, realizes three-dimensional joint inversion of multi-component, time domain and frequency domain signals, and forms a tunnel joint scanning imaging mode, which is used for predicting low resistance bodies in front of the tunnel; compared with the traditional algorithm, the computational efficiency and detection precision of inversion are improved; in addition, this method forms a self-checking mechanism from surface imaging and underground imaging, which can effectively identify false anomalies that may occur due to inversion multiplicity.

The present disclosure adopts the observation modes of surface transmission, underground reception, multi-source transmission and multi-component reception, realizes the omni-directional three-dimensional detection of the tunnel, and has the advantages of: a) being more convenient and efficient; b) a variety of signals complement each other and have good stability; c) avoiding electromagnetic coupling; d) mutual verification of multiple transmission; and e) dual imaging check mechanism: only when the predicted two imaging results are completely matched in space can the 3D spatial position of anomalous body be determined. This improves the accuracy of prediction to a certain extent and avoids misjudgment.

Thirdly, the expected income and commercial value after the technical scheme of the present disclosure is transformed are as follows;

1. Improve the safety of tunnel construction: the tunnel electromagnetic joint scanning detection technology can effectively detect the internal structure and geological conditions of the tunnel, provide accurate geological investigation and evaluation for tunnel construction, and prevent geological disasters in tunnel construction;

2. Reduce the cost of tunnel construction: through the application of tunnel electromagnetic joint scanning detection technology, the delay and rework in tunnel construction can be reduced, and the unreasonable design of tunnel structure can be avoided, thus reducing the cost of tunnel construction; and

3. Improve the efficiency of tunnel construction: the tunnel electromagnetic joint scanning detection technology can realize rapid and accurate detection of the internal structure and geological conditions of the tunnel, shorten the period of tunnel investigation and design, and improve the efficiency of tunnel construction.

The technical scheme of the disclosure solves the technical problem that people have been eager to solve, but have never been successful: the scheme of the disclosure essentially proposes a novel transient electromagnetic observation system and a parameter inversion method based on deep learning, so as to overcome the defects of the traditional tunnel electromagnetic imaging method, especially the defects of multi-solution, instability and poor continuity in TEM tunnel advanced detection. Moreover, the calculation efficiency is greatly improved, which can lay a foundation for real-time tunnel advanced prediction.

Fourthly, the following are the remarkable technological progress brought by each claim:

1): a new tunnel electromagnetic detection system is introduced, which adopts the mode of surface transmission and underground reception. Compared with the traditional detection mode, this detection method combining multi-component electromagnetic field information in time domain and frequency domain provides more comprehensive and higher resolution underground information.

2): three surface transmission sources are adopted to transmit electromagnetic field signals in turn, and two kinds of signals are transmitted alternately, so that the depth and breadth of detection are enhanced and richer data sources are provided.

3): the method of randomly setting transmission source is mentioned, this random strategy can increase the diversity of data, provide more comprehensive training data for the subsequent deep learning model, and improve the generalization ability of the model.

4): the technology of using deep learning algorithm for imaging is emphasized, and the detection technology is combined with the most advanced algorithm to make the imaging result more accurate and intuitive.

5): the process of establishing deep learning model is defined, including the establishment of resistivity model and the simulation of anomalous body, which provides a solid data foundation for subsequent neural network training.

6): the input structure and data preprocessing method of the neural network are described in detail, and the data input is optimized to ensure that the network can capture more effective information from the data.

7): the content and format of the neural network output are defined, and the spatial position information of the anomalous body is provided more clearly, so that the final user can interpret the result more easily.

8): describes the specific architecture and training method of the neural network, ensures the performance and stability of the model, and makes the whole detection method more reliable.

In general, each claim has been innovated and optimized on the basis of the existing technology, which has brought significant technical progress for tunnel electromagnetic detection and improved the accuracy and efficiency of detection.

### BRIEF DESCRIPTION OF THE DRAWINGS

FIG. 1 is a flowchart of a method for tunnel electromagnetic joint scanning detection according to one or more embodiments of the present disclosure;

FIG. 2 is a schematic diagram of an observation system for TEJS according to one or more embodiments of the present disclosure;

FIG. 3 is a schematic design diagram of a middle first layer channel of neural network input data according to one or more embodiments of the present disclosure;

FIG. 4 is the prediction result of the composite model UNet according to one or more embodiments of the disclosure, the lower left shows the relative position between the real model and the tunnel, the upper picture shows the surface scanning imaging, and the lower right picture shows the underground imaging of the tunnel; and

FIG. 5 is a schematic diagram of statistical analysis of prediction results according to one or more embodiments of the present disclosure, including (a) correct prediction results; (b) prediction results containing false anomalies; (c) prediction results of an average of 100 times; and (d) the standard deviation of the prediction results.

### DETAILED DESCRIPTION

In order to make the object, technical scheme and advantages of the present disclosure more clear, the present disclosure is described in further detail below in connection with the embodiments. It should be understood that the specific embodiments described herein are intended to explain the present disclosure only and are not intended to be a limit of the present disclosure.

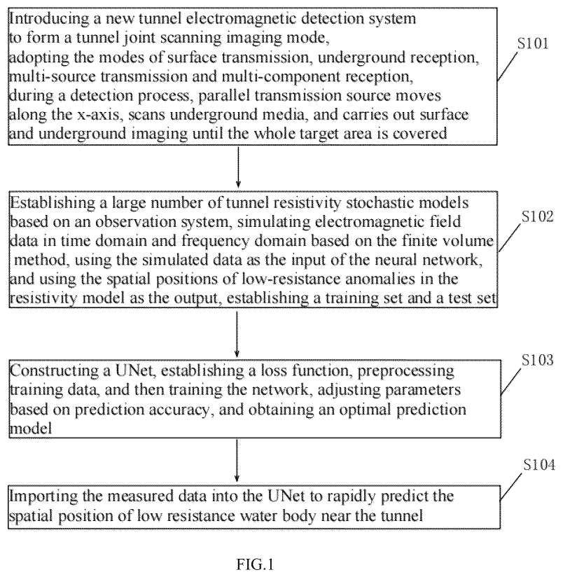

As shown in FIG. 1, the tunnel electromagnetic joint scanning detection method provided by the embodiment of the present disclosure comprises the following steps:

S101, using a new tunnel electromagnetic detection system to form a tunnel joint scanning imaging mode, adopting the modes of surface transmission, underground reception, multi-source transmission and multi-component reception, during a detection process, parallel transmission source moves along the x-axis, scans underground media, and carries out surface and underground imaging until the whole target area is covered;

S102, establishing a large number of tunnel resistivity stochastic models based on an observation system, simulating electromagnetic field data in time domain and frequency domain based on the finite volume method, using the simulated data as the input of the neural network, and using the spatial positions of low-resistance anomalies in the resistivity model as the output, establishing a training set and a test set;

S103, constructing a UNet, establishing a loss function, preprocessing training data, and then training network, adjusting parameters based on prediction accuracy, and obtaining an optimal prediction model; and

S104, importing the measured data into the UNet, to rapidly predict the spatial position of low resistance water body near the tunnel.

Each step provides a specific implementation scheme:

1. Step 101: Joint scanning imaging of tunnel electromagnetic detection system, comprising:

selecting appropriate electromagnetic transmission device and placing it on the ground to ensure that it can transmit stable and powerful electromagnetic signals;
Installing multi-component receivers in tunnels or underground, allowing them to receive electromagnetic signals emitted from the ground from different directions and angles;
controlling the ground transmission device to translate along the x-axis and move at a fixed speed and step to ensure that the whole target area is scanned; and
recording the electromagnetic response data of each point in the receiver and transmitting it to the data processing center in real time.

2. Step 102: Establishment and simulation of resistivity model, comprising:
generating stochastic resistivity models using a computer, which represent different underground structures and resistivity values;
using the finite volume method to simulate the electromagnetic responses of these resistivity models in time domain and frequency domain; and
based on the simulation results, preparing training data and test data for the neural network; the simulated electromagnetic response data is used as the input, and the corresponding resistivity distribution (especially the spatial position of low resistivity anomaly) is used as the output.

3. Step 103: Construction and training of UNet neural network, comprising:
Using existing deep learning frameworks (such as TensorFlow or PyTorch) to build the UNet network structure;
defining an appropriate loss function, such as mean square error loss, to measure the accuracy of network prediction;
performing necessary preprocessing, such as normalization and enhancement, on the training data; and
training the network with an optimizer (such as Adam or SGD), and using the validation data to detect the over-fitting of the model; and adjusting and optimizing parameters based on the prediction accuracy.

4. Step 104 **: Prediction of actual data, comprising:
inputting the measured electromagnetic response data into the trained UNet model;
outputting the predicted spatial position of the low resistance anomalous body by the network; and
based on these location informations, determining the location of water body or other low resistance body near the tunnel, and thus providing important information for tunnel construction and maintenance.

This implementation scheme provides a specific technical path for the method for tunnel electromagnetic joint scanning detection, but it needs to be further optimized and adjusted according to the specific geological conditions, device performance and actual needs in practical application.

The method for tunnel electromagnetic joint scanning detection according to one or more embodiments of the present disclosure comprises the following steps:
step 1. observation system: a new tunnel electromagnetic detection system called (Tunnel Electromagnetic Joint Scanning) TEJS is introduced, which realizes three-dimensional joint inversion of multi-component, time domain and frequency domain signals, and forms a tunnel joint scanning imaging mode, which is used to predict the low resistance body in front of the tunnel. This method adopts the mode of surface transmission, underground reception, multi-source transmission and multi-component reception. During a detection process, the parallel transmission source moves along the x-axis in order to scan the underground medium and image the surface and underground until the whole target area is covered. In each scanning step, three transmission sources are randomly arranged in separate sections (y∈[−30, −10], [−10, 10], [10, 30]) along the parallel direction of the X-axis; and it is also possible to use one transmission source to scan three sections in sequence;
step 2, establishing a training set by numerical simulation: establishing a large number of random models of tunnel resistivity, carrying out numerical simulation based on the new observation system, simulating electromagnetic field responses in time domain and frequency domain by using the finite volume method, taking the simulated data as the input of the neural network, and taking the spatial positions of low-resistance anomalies in the resistivity model as the output, including underground imaging and surface imaging, and establishing a training set and a test set; and
step 3, constructing an UNet and establishing a loss function; pre-processing the training data, and then training the network, adjusting the parameters based on the prediction accuracy to obtain an optimal prediction model; and the measured data are imported into UNet to rapidly predict the spatial position of low-resistivity water body near possible tunnels.

The construction of training set and UNet, training and prediction are described in detail below.

### 1. The Construction of Training Set

Firstly, a three-dimensional resistivity model is established, in which the resistivity changes linearly from shallow layer to deep layer, and the tunnel is filled with air, and there is also air above the ground. Subsequently, a low resistivity anomalous body is randomly introduced around the tunnel, and the distance from the tunnel excavation face varies from 10 meters to 35 meters. The resistivity values of these anomalous bodies follow the logarithmic uniform distribution log 10(ρ)∈[−1, 1] Ω·m. Then, the finite volume method (Heagy et al., 2017; 2020) is used for forward calculation in time domain and frequency domain in order to construct the training data set. On this basis, the UNet model is constructed and trained by using the generated data set (Ronneberger, 2015) (FIG. 3). The model is optimized by iterative adjustment of model parameters.

The inputs of the neural network include three-component time-domain induced electromotive force data and three-component frequency-domain magnetic field data, as well as frequency, turn-off time and spatial information channels (FIG. 3). The spatial information channel includes vector information from the measurement point to the transmission source, which is represented by azimuth and polar angle, and is represented by the distance in spherical coordinates, which is represented as three one-dimensional vectors, in which each element of the vector is equal. In order to reduce the order of magnitude difference and retain important information, two processing methods are applied to time domain and frequency domain data. The processed data is then used as two separate channels: (1) standardized and (2) logarithmic after absolute value. Considering the existence of three transmission source, each sample data includes a total of six channels (FIG. 3).

The upper part of FIG. 3 shows the first layer channel design of neural network input data, and each frequency domain data contains both real and imaginary information. R, θ, φ is the spherical coordinates of transmission source relative to the observation point. The lower part of FIG. 3 shows the model design of UNet model to realize tunnel advanced prediction. Input consists of six layers, and each two layers of data corresponds to the position of a transmission source. The structure of the first layer of data in the two layers is as shown in the upper part of FIG. 3, and the second layer is the result of taking the absolute value of the first layer and then taking the logarithm to improve the proportion of effective information.

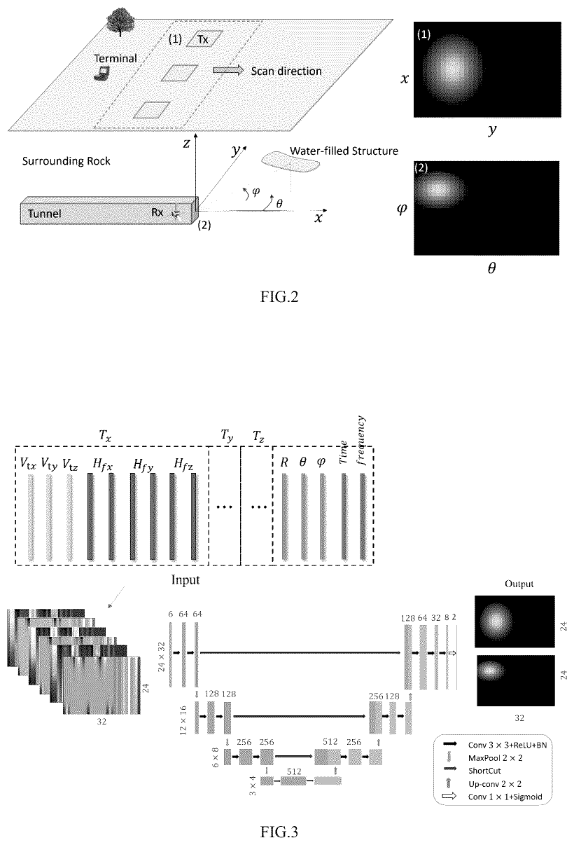

The output of the neural network includes two channels:
(a) underground imaging: in order to be consistent with the two-dimensional output structure of the network, a spherical coordinate system is established, with the anomalous body center as the target point and the receiving coil position as the origin (FIG. 2). Then, θ is used as the horizontal coordinate and φ as the vertical coordinate to represent the spatial position information of the model. Considering the inherent deviation and uncertainty of predicting the actual position of anomalous body, a two-dimensional Gaussian distribution is applied around the generated model position, and the highest point represents the position of anomalous body (Zhu and Beroza, 2018). This method effectively reduces the influence of position error in data set. In the prediction stage, the precise position of anomalous body can be determined by identifying the peak value of probability distribution in the prediction result; and
(b) surface imaging: Underground imaging only provides spatial positioning of anomalous body, but lacks information on the distance between anomalous body and observation points. In order to overcome this limitation, surface imaging is adopted, and the position of anomalous body is projected onto the surface, and the imaging position corresponds to the positions of three parallel transmission sources. Through surface scanning, combined with underground imaging, the spatial position of anomalous body can be determined.

### 2. Construction and Training of Neural Network

The present disclosure intends to use a UNet network to predict the nonlinear mapping between TEM signal and model space (FIG. 3). The model adopts a ReLU activation function and applies it to the output of convolution layers. After convolution operations, batch normalization is applied to standardize the data, which further prevents gradient disappearance or explosion and enhances the regularization effect. A Sigmoid function is applied to the last layer, limiting the output to [0, 1]. The optimum hyperparameters for the step size and filter core size will be determined according to many tests to determine the most appropriate values. In order to evaluate the performance of the UNet network, cross entropy function (Zhang and Sabuncu, 2018) is used to measure the proximity between prediction variable q_i(x) and corresponding label p_i(x):

$$H ( p , q ) = {H}_{1} ( p , q ) + {H}_{2} ( p , q )$$

$${H}_{1} ( p , q ) = - {\sum }_{i = 1}^{2} {\sum }_{x} {p}_{i} ( x ) log {q}_{i} ( x )$$

$${H}_{2} ( p , q ) = - {\sum }_{i = 1}^{2} {\sum }_{x} {p}_{i} ( x ) log {q}_{i} ( x )$$

where, i=1 and i=2 denote the presence or absence of a low resistivity anomaly respectively, and x denotes the spatial position of the output neuron. H_1 and H_2 correspond to the output channels of surface imaging and underground imaging respectively.

### 3. Prediction of the Model

Based on the step 2, an effective deep learning prediction model is established, and then the designed observation system is arranged in the actual tunnel situation to collect data, and then the collected data is imported into the input of the deep learning model, so that the prediction result of whether there is a water body with low resistance can be obtained, thus providing important information for judging whether there is a potential safety hazard in front of the tunnel.

The following are four specific embodiments and implementation schemes, covering the specific steps of the method for tunnel electromagnetic joint scanning detection and the new tunnel electromagnetic observation system in claim 1:

### Embodiment 1: Tunnel Joint Scanning Detection Method

A new observation system for surface transmission-underground observation is designed. Based on the time domain and frequency domain data obtained by numerical simulation, a deep learning model is established to predict the low-resistance water-bearing anomalies in front of and around the tunnel in three-dimensional space.

### Embodiment 2: Dual Imaging Mutual Check Mechanism

Neural network can realize underground imaging and surface imaging at the same time. Underground imaging determines the azimuth information of the anomaly, and surface scanning imaging determines the plane spatial position of the anomaly. The combination of the two can accurately estimate the three-dimensional spatial position of the anomaly. If the two imaging results are contradictory, it shows that there is a great uncertainty in the prediction results, and it is necessary to change the instrument parameters (transmission current, coil size, etc.) or re-predict the y coordinate of the scanning source.

### Embodiment 3: Theoretical Model Testing of the Prediction Model

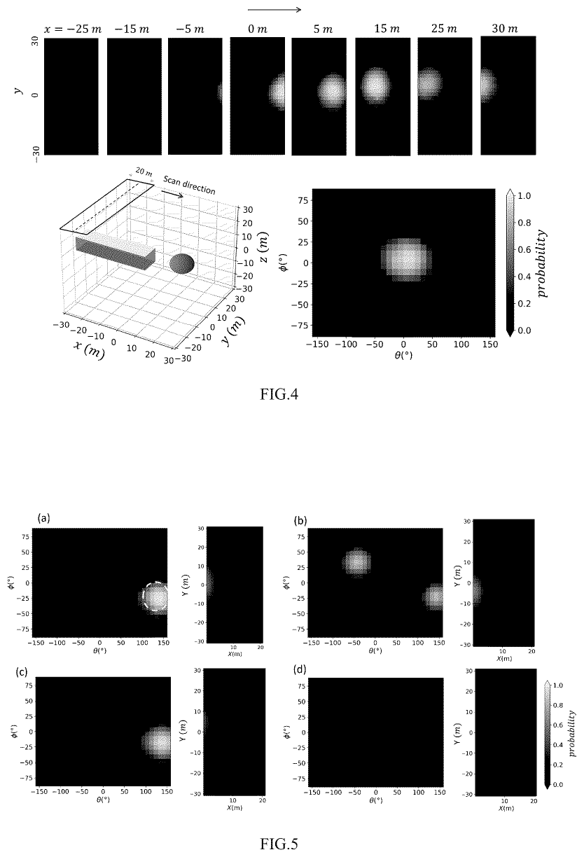

A model as shown in the lower left part of FIG. 4 is designed. In this model, a spherical anomaly is placed right in front of the tunnel, its coordinates are [13.5, 4, −3.3], and its resistivity is 1.6 Ω·m; Three mutually parallel transmitting coils are placed on the ground and scanned from left to right; a receiving coil is placed at (y∈[−30, −10], [−10, 10], [10, 30]) to realize the joint detection of anomalous bodies. The upper part of FIG. 4 shows the surface imaging results when the transmitting coils are located at different positions. It can be seen that when the transmitting coils are close to the right above the abnormal body, the abnormal body gradually appears on the right side of the prediction result, and the anomalous body is located in the middle at 15 m closest to the right above the anomalous body. When the transmitting coils are farther away from the anomalous body, the anomalous body in the prediction result will eventually disappear. The lower right part of FIG. 4 shows the underground imaging results of the UNet, and the specific meaning of its horizontal and vertical coordinates is shown in FIG. 2. The prediction results show that anomalous body is roughly located about 12 m in front of the tunnel and slightly deviates from the positive direction of the y-axis, which is consistent with the real model. By synthesizing the two prediction results of the UNet, the present disclosure can obtain the three-dimensional spatial position of the anomalous body. The above results show that the tunnel electromagnetic advance prediction algorithm proposed by the present disclosure determines the three-dimensional spatial position of the anomalous body by using the prediction result of the XY plane and the orientation information of the low-resistance anomalous body in the three-dimensional space, and the prediction result is precise and reliable.

### Embodiment 4: Uncertainty Test of Prediction Model

An important advantage of data-driven deep learning inversion method is that it can realize rapid model prediction, which can help statistical analysis of inversion results, thus facilitating the evaluation of its uncertainty. To achieve this, for a model with anomalous body at position [−8.3, 8.4, −47], the present disclosure simulates 100 different sets of observation data by changing the position of the transmission source, where the three transmission sources share an x-coordinate of 10 meters but have different y-coordinates, different transmission currents and transmission coils of different size. The depth of the tunnel is set at 33 meters. In addition, the present disclosure applies 5% Gaussian noise to analog data. Subsequently, 100 prediction results were generated using the UNet. Two of the prediction results are shown in part (a) of FIG. 5 and part (b) of FIG. 5, and the white circle denotes the position of the real anomaly. Obviously, due to the inherent non-uniqueness of inversion, the prediction results are different. It is worth noting that compared with part (a) of FIG. 5, part (b) of FIG. 5 shows an extra anomalous body on the left. In addition, the surface imaging result in part (b) of FIG. 5 shows a deviation in the negative direction of Y-axis, which is consistent with the underground imaging result. Therefore, it is difficult to determine whether the anomalous body in the negative direction of Y-axis in part (b) of FIG. 5 is a true anomaly.

To solve this problem, the present disclosure averages 100 prediction results, as shown in part (c) of FIG. 5. It can be observed that the surface imaging results tend to be in the positive direction of Y-axis. This shows that the anomalous body along the negative direction of Y-axis is a false anomaly, because it cannot produce surface anomalies in the positive direction of Y-axis. Therefore, by making multiple predictions and averaging them, combined with self-checking mechanism, false anomalies can be effectively identified, the influence of inversion non-uniqueness can be reduced, and the interpretability of inversion results can be improved. In addition, part (d) of FIG. 5 shows the standard deviation of 100 prediction results, which is an indicator of uncertainty of prediction results. This shows that both real anomalies and false anomalies may have uncertainties. However, by considering the average statistical results and using self-checking mechanism, it is easier to determine the existence of real anomalies.

The above embodiment and implementation scheme describe the method for tunnel electromagnetic joint scanning detection and the specific steps of the new tunnel electromagnetic observation system. Through these steps, the scanning of underground media and surface imaging can be realized, and the potential information such as low resistance water body near the tunnel can be detected, which provides a more effective and high-precision method for tunnel engineering investigation and geological exploration.

Based on the method for tunnel electromagnetic joint scanning detection of the present disclosure, the following is a specific embodiment and implementation schemes thereof:

### Embodiment 1: Tunnel Electromagnetic Detection Based on Mobile Vehicle Platform

1) Vehicle platform: use an automated vehicle platform with tires, which is equipped with three surface transmission sources.

2) Transmission signal control: a microcontroller is mounted to control the transmission source, and step current signals and harmonic signals are transmitted in turn according to the method.

3) Data reception and transmission: after data is collected by the receiving coil, the data is sent to the data processing center through the wireless module.

4) Real-time deep learning analysis: the data processing center receives data in real time and uses the trained UNet model to predict, so as to rapidly identify the spatial position of the low-resistance anomalous body.

5) Anomalous body prompt system: when anomalous body is detected, the vehicle platform will display the anomalous position in real time and give an audible and visual alarm.

This embodiment provides a different implementation of tunnel electromagnetic detection, which can be selected and adjusted according to actual application scenarios and requirements.

It should be noted that embodiments of the present disclosure may be implemented by hardware software or a combination of software and hardware. The hardware part can be realized by special logic. The software portion may be stored in memory and executed by a suitable instruction execution system such as a microprocessor or specially designed hardware. Those skilled in the art can understand that the above-mentioned devices and methods can be implemented using computer-executable instructions and/or contained in processor control code, for example, such code is provided on a carrier medium such as a magnetic disk, a CD or DVD-ROM, a programmable memory such as a read-only memory (firmware) or a data carrier such as an optical or electronic signal carrier. The device and its modules of the present disclosure can be realized by hardware circuits such as very large scale integrated circuits or gate arrays, semiconductors such as logic chips and transistors, or programmable hardware devices such as field programmable gate arrays and programmable logic devices, or by software executed by various types of processors, or by a combination of the above hardware circuits and software such as firmware.

The above merely describes specific embodiments of the present disclosure, which is not intended to limit the scope of protection of the present disclosure. Any modifications, equivalent variations or substitutions, and improvements made within the spirit and principle of the present disclosure by those skilled in the art according to the disclosed technical scope should be included in the protection scope of the present disclosure.

What is claimed is:

1. A method for tunnel electromagnetic joint scanning detection, comprising:
step 1, using a tunnel electromagnetic detection system to form a tunnel joint scanning imaging mode, adopting the modes of surface transmission, underground reception, multi-source transmission and multi-component reception, during a detection process, parallel transmission source moves along the x-axis, scans underground media, and carries out surface and underground imaging until a whole target area is covered;
step 2, establishing a large number of tunnel resistivity stochastic models based on an observation system, simulating electromagnetic field data in time domain and frequency domain based on a finite volume method, using the simulated data as the input for a neural network, and using the spatial positions of low-resistance anomalies in the resistivity model as the output, establishing a training set and a test set;
step 3, constructing a UNet, establishing a loss function, preprocessing the training data, and then training network, adjusting parameters based on prediction accuracy, and obtaining an optimal prediction model; and
step 4, importing the measured data into the UNet to rapidly predict the spatial position of low resistance water body near the tunnel

2. The method for tunnel electromagnetic joint scanning detection according to claim 1, wherein the step 1 comprises:
selecting appropriate electromagnetic transmission device and placing it on the ground to ensure that it can transmit stable and powerful electromagnetic signals;
Installing multi-component receivers in tunnels or underground, allowing them to receive electromagnetic signals emitted from the ground from different directions and angles;
controlling the ground transmission device to translate along the x-axis and move at a fixed speed and step to ensure that the whole target area is scanned; and
recording the electromagnetic response data at each point in the receivers and transmitting it to the data processing center in real time.

3. The method for tunnel electromagnetic joint scanning detection according to claim 1, wherein the step 2 comprises:
generating stochastic resistivity models using a computer, which represent different underground structures and resistivity values;
using the finite volume method to simulate the electromagnetic responses of these resistivity models in time domain and frequency domain; and
based on the simulation results, preparing training data and test data for the neural network; the simulated electromagnetic response data is used as input, and the corresponding resistivity distribution is used as output.

4. The method for tunnel electromagnetic joint scanning detection according to claim 1, wherein the step 3 comprises:
using existing deep learning frameworks to build the UNet network structure;
defining an appropriate loss function, such as mean square error loss, to measure the accuracy of network prediction;
carrying out necessary preprocessing on the training data; and
training the network with an optimizer, using the verification data to detect the over-fitting of the model; and adjusting and optimizing parameters based on the prediction accuracy.

5. The method for tunnel electromagnetic joint scanning detection according to claim 1, wherein the step 4 comprises:
inputting the measured electromagnetic response data into the trained UNet model;
outputting the predicted spatial position of the low resistance anomalous body by the network; and
based on these location information, determining the location of water body or other low resistance body near the tunnel, and thus providing important information for tunnel construction and maintenance.

6. The method for tunnel electromagnetic joint scanning detection according to claim 2, wherein three parallel surface transmission sources are used to transmit electromagnetic field signals in turn, a receiving coil works near the excavation surface, and a transmitting coil alternately transmits two types of signals, wherein:
the first type is a step current signal, which is used to generate pulsed electromagnetic field for TEM detection;
the second type is a harmonic signal, the received signal is converted into frequency domain magnetic field signal by fast Fourier transform, and the observation mode of three components (x, y, z) is adopted; and
in each scanning step in the step 1, three transmission sources are randomly arranged in separate sections (y∈[−30, −10], [−10, 10], [10, 30]) along the parallel direction of the x-axis, or one transmission source can be used to scan the three separate sections in sequence; and the tunnel electromagnetic joint scanning detection method takes the simulated observation data corresponding to the three transmission sources as a training sample.

7. The method for tunnel electromagnetic joint scanning detection according to claim 2, wherein the neural network input of the method for tunnel electromagnetic joint scanning detection in the step 2 comprises three-component time-domain induced electromotive force data and three-component frequency-domain magnetic field data, and frequency, turn-off time and spatial information channels, wherein the spatial information channels are vector information from the measurement point to the transmission source, which are represented by azimuth and polar angles, and are represented by distances in spherical coordinates, and are represented by three one-dimensional vectors; two processing methods are applied to time-domain and frequency-domain data, and the processed data are used as two separate channels: (a) standardization and (b) logarithm after absolute value; and when each transmitter transmits signals, it collects data from two channels to improve the proportion of effective information, so each sample data includes input data from six channels.

8. The method for tunnel electromagnetic joint scanning detection according to claim 2, wherein the output of the method for neural network of the tunnel electromagnetic joint scanning detection in the step 2 comprises two channels, and the output result is the inversion imaging result, including:
(a) underground imaging: a spherical coordinate system is established, with the center of the anomalous body as the target point and the position of the receiving coil as the origin; then, θ is used as the horizontal coordinate and φ is used as the vertical coordinate to represent the spatial position information of the model, and a two-dimensional Gaussian distribution is applied around the generated model position, and the highest point represents the position of the anomalous body; in the prediction stage, the precise position of the anomalous body is determined by identifying the peak value of the prediction probability distribution; and
(b) surface imaging: Gaussian distribution of underground low-resistivity anomalies projected on the surface, and the projection area is a rectangular area of the surface consisting of three transmission sources.

9. The method for tunnel electromagnetic joint scanning detection according to claim 2, wherein the construction and training of the neural network of the method for tunnel electromagnetic joint scanning detection in the step 3 comprises: a UNet network is used to predict the nonlinear mapping between electromagnetic signals and the spatial distribution of low-resistance anomalies, and the model adopts a ReLU activation function, which is applied to the output of convolution layer; after convolution operations, batch normalization is applied to standardize the data, a Sigmoid function is applied to the last layer, and the output result is limited to the range [0,1]; the optimal hyperparameters of step size and filter kernel size are determined through multiple tests to find the most suitable values, and the cross entropy function are used to measure the closeness between the predicted variable q_i(x) and the corresponding label p_i(x), where:
$$H ( p , q ) = {H}_{1} ( p , q ) + {H}_{2} ( p , q )$$
$${H}_{1} ( p , q ) = - {\sum }_{i = 1}^{2} {\sum }_{x}^{} {p}_{i} ( x ) log {q}_{i} ( x )$$
$${H}_{2} ( p , q ) = - {\sum }_{i = 1}^{2} {\sum }_{x}^{} {p}_{i} ( x ) log {q}_{i} ( x )$$
i=1 and i=2 denote the presence or absence of the low resistivity anomalies respectively, x denotes the spatial location of the output neurons, and H1 and H2 correspond to the output channels of surface imaging and underground imaging respectively.

10. A system for tunnel electromagnetic joint scanning detection, which is used for the operation of the method for tunnel electromagnetic joint scanning detection of claim 1, wherein the system for tunnel electromagnetic joint scanning detection comprises:
a tunnel electromagnetic observation module, which is used to collect effective electromagnetic field information;
a training set and test set module, which is used to train and test tunnel resistivity stochastic model;
a prediction model optimization module, which is used to optimize the model to obtain an optimal prediction model; and
a rapid prediction module, which is used to rapidly predict the spatial position of low resistance water body near the tunnel.
